(19) United States
(12) Patent Application Publication
(10) Pub. No.: US 2026/0176995 A1
(43) Pub. Date: Jun. 25, 2026

(54) SUPPORT STRUCTURE FOR A HEATING MATRIX

(71) Applicant: Schaeffler Technologies AG & Co. KG, Herzogenaurach (DE)

(72) Inventors: Rolf BRÜCK, Bergisch Gladbach (DE); Jan HODGSON, Troisdorf (DE); Alexander MÖSELER, Neunkirchen-Seelscheid (DE)

(21) Appl. No.: 19/127,223

(22) PCT Filed: Nov. 16, 2023
(86) PCT No.: PCT/EP2023/082082

§ 371 Date: May 5, 2025

(30) Foreign Application Priority Data
Nov. 17, 2022 (DE) 10 2022 212 258.5

(51) Int. Cl. F01N 3/20

(52) U.S. Cl. CPC F01N 3/2026; F01N 3/2066

(57) ABSTRACT

A support structure for positioning a heating matrix in an exhaust gas line spatially delimited by a housing, the heating matrix formed by a honeycomb body. The heating matrix is supported against the inner surface of the housing by the support structure and the matrix is fixed with respect to the support structure by coupling elements, which are plugged into and durably connected to individual cells of the heating matrix, which are formed by the flow channels. The respective free end of a coupling element is directly or indirectly connected to the support structure, a respective tolerance compensation element that compensates for a positional tolerance of the coupling element in at least two spatial directions being provided.

### CROSS REFERENCE TO RELATED APPLICATIONS

This is a U.S. national stage of Application No. PCT/EP 2023/082082 filed Nov. 16, 2023. Priority is claimed on German Application No. DE 10 2022 212 258.5 filed Nov. 17, 2022, the contents of which are incorporated herein by reference.

### BACKGROUND OF THE INVENTION

### 1. Field of the Invention

The disclosure relates to a support structure for positioning a heating matrix in an exhaust gas line spatially delimited by a housing, the heating matrix being formed by a honeycomb body that has a multiplicity of flow channels through which flow can pass in a main flow direction, wherein the heating matrix is supported against the inner surface of the housing by the support structure and the matrix is fixed with respect to the support structure by a plurality of coupling elements, the coupling elements being plugged into and durably connected to individual cells of the heating matrix, which are formed by the flow channels. The disclosure also relates to a method for connecting a support structure to a heating matrix.

### 2. Description of the Related Art

Nowadays, electrical heating elements are often used to heat exhaust gases in an exhaust gas line downstream of an internal combustion engine, or the exhaust gas flowing in an exhaust gas line. The aim here is to more quickly reach a temperature threshold from which effective transformation of the pollutants entrained in the exhaust gas can take place. This is necessary because the catalytically active surfaces, used for exhaust gas aftertreatment, of the catalytic converters installed in the exhaust gas line only allow sufficient conversion of the respective pollutants from a minimum temperature, known as the light-off temperature.

The known solutions in the prior art include what are known as heated catalytic converters, which have a metallic structure connected to a voltage source or a metal-coated ceramic structure which can be heated up by exploiting ohmic resistance.

The heatable metallic structures can consist, for example, of a honeycomb body produced from metal foils. To do this, a plurality of smooth and/or at least partially structured metal foils are stacked one on top of another and are wound about at least one pivot point to form a honeycomb body. The matrix formed from the metal foils can be electrically contacted and be heated by exploiting ohmic resistance.

For this purpose, the matrix must be arranged in an exhaust gas line and situated up-stream or downstream, in the direction of flow of the exhaust gas, of a catalytic converter designed for exhaust gas aftertreatment.

In order to position the matrix in the exhaust gas line and support it in particular with respect to mechanical and thermal loading which arises in particular with the high alternating thermal loading and also with the strong and uneven mechanical loading in an exhaust gas line, in particular the exhaust gas line of a motor vehicle, it is necessary to provide a mount.

The support structure and the heating matrix are connected via a plurality of coupling elements. Because all components are subject to certain production-related manufacturing tolerances, it is necessary to establish a tolerance compensation to enable a stress-free mounting. A disadvantage of the known solutions in the prior art is in particular that the tolerance compensation of the known coupling elements is not sufficient.

### SUMMARY OF THE INVENTION

One object of the present invention is therefore to provide a support structure for a heating matrix which has advantageous coupling elements that permit sufficient tolerance compensation. One object of the invention is also to provide a method for connecting the support structure to the heating matrix.

One aspect embodiment of the invention relates to a support structure for positioning a heating matrix in an exhaust gas line spatially delimited by a housing, the heating matrix being formed by a honeycomb body that has a multiplicity of flow channels through which flow can pass in a main flow direction, wherein the heating matrix is supported against the inner surface of the housing by the support structure and the matrix is fixed with respect to the support structure by a plurality of coupling elements, the coupling elements being plugged into and durably connected to individual cells of the heating matrix, which are formed by the flow channels, wherein the respective free end of a coupling element is directly or indirectly connected to the support structure, a respective tolerance compensation element that compensates for a positional tolerance of the coupling element in at least two spatial directions being provided.

The tolerance compensation is necessary because all components have attendant production-related tolerances. For a precise assembly, the compensation is therefore imperative. In addition to the production-related tolerances, there is also a tolerance owing to the fact that the coupling elements must be plugged into cells of the honeycomb body. Here, slight deviations can sometimes occur and furthermore, owing to a dimensional tolerance of the honeycomb body, a coupling element may deviate slightly from its basic position.

The tolerance compensation is preferably provided in the region where the coupling element is attached to the support structure, since the attachment to the honeycomb body offers virtually no compensation possibilities.

The coupling element, which may be formed for example by a support pin known in the prior art, or, depending on the electrical insulation requirement, by a simple metal pin, can be attached to the support structure directly or using an intermediate element.

Two of the three spatial directions in which a tolerance compensation needs to take place span the plane in which the support structure lies. The third spatial direction extends as a surface normal to this plane. In the two first spatial directions, a positional tolerance of the coupling element is substantially compensated for, if the coupling element is plugged for example into a cell adjacent to the actual target cell or the honeycomb body has a manufacturing tolerance in this region. In the third spatial direction, which is the direction in which the coupling elements are plugged into the honeycomb body, a tolerance in the axial direction of the exhaust gas line is compensated for. Usually, the tolerance in the third direction is smaller than in the first two directions, since the plug-in depth into the honeycomb body is very precisely controlled by machine and the deviations are therefore small.

It is particularly advantageous if the support structure, on its surface facing toward the heating matrix, has cup-like chambers which are open toward the heating structure, are each designed to receive a free end of a coupling element, and form the tolerance compensation elements.

The support structure, which is formed substantially from flat metal sheets, can have cup-like chambers. They can be formed directly on that surface of the support structure that faces toward the heating matrix. The chambers may be directly molded into the metal sheet material, for example by deep drawing or embossing. As an alternative, the chambers may also be formed by a cylindrical collar that extends from the support structure.

It is also advantageous if the clear opening width of the cup-like chambers is in each case a multiple of the cross section of a free end of a coupling element. The free end of the coupling element can then be pushed inside the clear opening in the first two spatial directions. Varying the plug-in depth of the free end of the coupling element also allows a tolerance compensation in the third spatial direction. The size of the clear opening at the same time determines the maximum possible tolerance compensation in the first two spatial directions, while the depth of the chambers substantially determines the maximum possible tolerance compensation in the third spatial direction.

A preferred aspect is characterized in that the depth of the cup-like chambers is greater than the average plug-in depth of the coupling elements. This ensures that a sufficient degree of tolerance compensation is possible.

The chambers can be pre-filled with a solder, so that a durable connection between the support structure and the heating matrix can be established with a simple soldering method after the coupling elements have been plugged in.

In an alternative configuration, it is preferred if between the support structure and a coupling element in each case there is a connecting element in the form of a tolerance compensation element, which is durably connected to the support structure on one side and receives the free end of the coupling element on the other side.

A further connecting element may be advantageous in order to compensate the tolerances. A connecting element may be formed for example by a hollow cylinder that is closed at one end and is applied to the surface of the support structure. The hollow cylinder may also be pre-filled with a solder.

Furthermore, it is advantageous if the connecting element has an opening which faces toward the coupling element and is larger than the cross section of the free end of the coupling element. If it is essentially necessary for a tolerance compensation to take place in one of the two first spatial directions, an elongate opening can be provided. As an alternative, a circular or rectangular opening cross section may be selected.

One exemplary aspect of the invention relates to a method for connecting the support structure to the heating matrix, wherein the connecting elements firstly are durably connected to the coupling elements and in a subsequent step are durably connected to that surface of the support structure that faces toward the heating matrix.

Depending on the production process selected, the connecting element may firstly be connected to the free end of the coupling element. A possible positional tolerance of the coupling element may in this case be transferred to the connecting element. This applies in particular to tolerances in the first two spatial directions. Tolerances in the third spatial direction may already be compensated for by correcting the depth to which the coupling element is plugged into the connecting element.

The coupling elements are durably connected to the connecting elements by a suitable method. This is then followed by the attachment to the support structure. Because the positional tolerances were transferred to the connecting elements, what can happen here is that the connecting elements deviate from the originally planned position of the connecting elements by these very tolerances. This can be counteracted by making the support structure wider in the region of the planned position of the respective connecting elements.

The connecting elements preferably have a smooth surface which faces toward the sup-port structure and via which attachment to the support structure can easily take place.

The opening width for plugging in the coupling elements in this case only needs to be marginally larger than the free ends of the coupling elements, since the tolerance compensation in this case takes place only in the third spatial direction and the compensation of the first two spatial directions takes place after that by varying the position of the connecting element relative to the support structure.

In an alternative method, it is expedient if the connecting elements are durably connected to that surface of the support structure that faces toward the heating matrix in a first step and the coupling elements are plugged into and durably connected to the connecting elements in a subsequent step.

As an alternative, firstly the connecting elements are attached to the support structure. The clear opening of the connecting elements in this case needs to be large enough to allow a tolerance compensation in the first two spatial directions. The third spatial direction is compensated for by adapting the plug-in depth.

Advantageous developments of the present invention are described in the dependent claims and in the description of the figures that follows.

### BRIEF DESCRIPTION OF THE DRAWINGS

The invention is explained in detail below on the basis of exemplary embodiments with reference to the drawings, in which:

FIG. 1 is a partial view of a support structure with a plurality of connecting elements which are attached to the support structure and have different positions relative to the support structure;

FIG. 2 is a partial view of a support structure with a plurality of connecting elements arranged at predefined positions on the support structure;

FIG. 3 is a sectional view through two connecting elements with a coupling element plugged into each, the coupling element being fixed in the connecting element by a clamp; and FIG. 4 is a coupling element which is received at each end in chambers in the form of cups.

### DETAILED DESCRIPTION OF THE PRESENTLY PREFERRED EMBODIMENTS

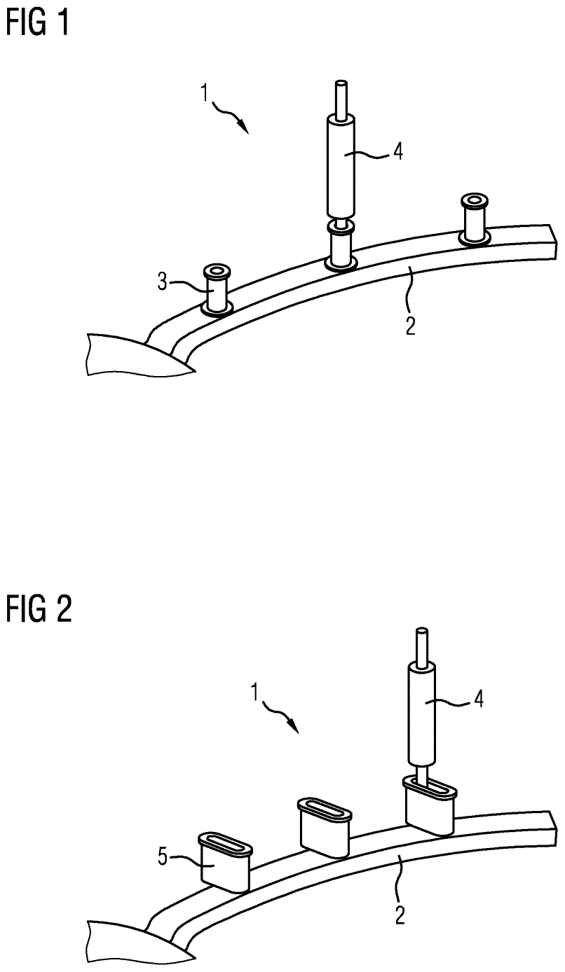

FIG. 1 shows a support structure 1 which has multiple connecting elements 3 on one of its struts 2. A coupling element 4 can be plugged into each of the connecting elements 3. The support structure 1, the connecting elements 3 and the coupling elements 4 can be durably interconnected by a soldering method.

In the example in FIG. 1, the connecting elements 3 are firstly connected to the coupling elements 4, which in turn have been plugged into cells of a heating matrix and connected thereto. The positional tolerances resulting from the production-related tolerances of the heating matrix are transferred to the connecting elements 3 via the coupling elements 4. Therefore, the connecting elements 3, illustrated here on the central connecting element 3, are not arranged centrally on the strut 2, but slightly offset from its center at times.

FIG. 2 shows connecting elements 5 on a strut 2 of a support structure 1. The connecting elements 5 have an elongate opening which allows a tolerance compensation in one of the first two spatial directions. The connecting elements 5 are firstly connected to the strut 2 of the support structure 1 before the coupling elements 4 are plugged into them. Therefore, the connecting elements 5 are also distributed very evenly over the strut 2.

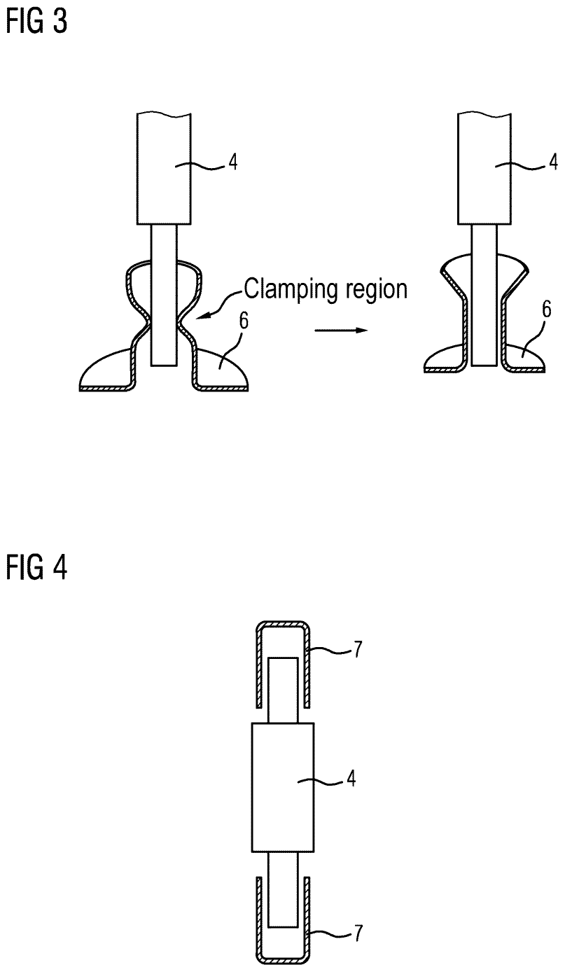

FIG. 3 shows a sectional view through a coupling element 4, one end of which has been plugged into a connecting element 6. The coupling element 4 is connected to the connecting element 6 by a clamp. It may be a first fixation before a durable connection is established by soldering.

FIG. 4 shows a coupling element 4, both ends of which have been plugged into hollow-cylindrical receptacles 7. In this case, in particular the positional tolerance in the third spatial direction can be compensated for by varying the plug-in depth.

The different features of the individual exemplary embodiments can also be combined with one another.

The exemplary embodiments of FIGS. 1 to 4 have in particular no limiting character and serve to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A support structure configured to position a heating matrix in an exhaust gas line spatially delimited by a housing, the heating matrix being formed by a honeycomb body which has a multiplicity of flow channels through which flow can pass in a main flow direction, wherein the heating matrix is supported against an inner surface of the housing by the support structure and the heating matrix is fixed with respect to the support structure, the support structure comprising:
a plurality of coupling elements, the plurality of coupling elements being plugged into and durably connected to individual cells of the heating matrix, which are formed by the flow channels; and
a respective free end of a respective coupling element is directly or indirectly connected to the support structure, a respective tolerance compensation element that compensates for a positional tolerance of the coupling element in at least two spatial directions being provided.

11. The support structure as claimed in claim 10, wherein the support structure, on its surface facing toward the heating matrix, further comprises cup-like chambers which are open toward the heating structure, and configured to receive a free end of a respective coupling element, and form the tolerance compensation elements.

12. The support structure as claimed in claim 11, wherein a clear opening width of the cup-like chambers is in each case a multiple of a cross section of a free end of the coupling element.

13. The support structure as claimed in claim 11, wherein a depth of the cup-like chambers is greater than an average plug-in depth of the coupling elements.

14. The support structure as claimed in claim 10, wherein between the support structure and a coupling element in each case there is a connecting element in the form of the tolerance compensation element, which is durably connected to the support structure on one side and receives the free end of the coupling element on an other side.

15. The support structure as claimed in claim 14, wherein the connecting element has an opening which faces toward the coupling element and is larger than a cross section of the free end of the coupling element.

16. The support structure as claimed in claim 14, wherein the connecting element has an elongate opening.

17. A method for connecting a support structure configured to position a heating matrix in an exhaust gas line spatially delimited by a housing, the heating matrix being formed by a honeycomb body which has a multiplicity of flow channels through which flow can pass in a main flow direction, wherein the heating matrix is supported against an inner surface of the housing by the support structure and the matrix is fixed with respect to the support structure, comprising:
connecting elements firstly are durably connected to coupling elements; and
in a subsequent step durably connecting the connecting elements to that surface of the support structure that faces toward the heating matrix.

18. A method for connecting a support structure configured to position a heating matrix in an exhaust gas line spatially delimited by a housing, the heating matrix being formed by a honeycomb body which has a multiplicity of flow channels through which flow can pass in a main flow direction, wherein the heating matrix is supported against an inner surface of the housing by the support structure and the matrix is fixed with respect to the support structure, comprising:
durably connecting elements to that surface of the support structure that faces toward the heating matrix in a first step; and
plugging and durably connecting coupling elements to the connecting elements in a subsequent step.
